(19) United States
(12) Patent Application Publication
(10) Pub. No.: US 2019/0251644 A1
(43) Pub. Date: Aug. 15, 2019

(54) METHOD AND SYSTEM FOR RAPID NOTIFICATION OF NEW REAL ESTATE LISTINGS

(71) Applicant: Gregory D. Hague, Scottsdale, AZ (US)

(72) Inventor: Gregory D. Hague, Scottsdale, AZ (US)

(21) Appl. No.: 15/893,355

(22) Filed: Feb. 9, 2018

(51) Int. Cl. G06Q 50/16; G06Q 30/02; G06Q 30/06; H04L 29/08

(52) U.S. Cl. CPC G06Q 50/16; G06Q 30/0258; G06Q 30/0635; G06F 3/04817; H04L 67/26; H04L 67/02; G06Q 30/0267

(57) ABSTRACT

A listing and notification server receives real estate listing information from a mobile device of a real estate agent situated at a location where a listing agreement has moments before been entered into. The mobile device is preferably a smartphone that allows the agent to take various photos and video of the property, which can be uploaded together with a description of the property. The server pushes notifications of the new listing to a plurality of subscriber computing devices. The subscribers may include persons who indicated interest in buying real estate. The system can be configured such that notifications are sent to subscribers based on predetermined criteria, e.g., a specified price range. The listing information is added to a real estate listing database, which is a closed database searchable only by the subscribers. After a few days, the listing is removed from the real estate listing database to ensure freshness.

### BACKGROUND OF THE INVENTION

### 1. Field of the Invention

The present invention relates to a method and system for rapid notification of new real estate listings.

### 2. Description of the Related Art

The current process for a newly listed home for sale is that a real estate agent takes measurements and photographs of the property, and within a day or two, enters listing information into a multiple listing service (MLS). An MLS is a service used by a group of real estate brokers that allows each broker to see properties listed by the other brokers, and to share in commissions. MLS rules in most areas allow 48 hours for agents to enter a newly-listed-home-for-sale into the MLS unless the seller agrees to wait longer. In most cases homes would appear in MLS on the second or third day after they are entered. Also, such newly-listed-homes-for-sale would appear on various real estate aggregators (e.g., Zillow) at about the same time. That is also about when the “for sale” sign goes up, taking into consideration the time it takes for the listing agent to order the sign, and a sign company to place the sign up on the property. Accordingly, under the current process, prospective homebuyers do not learn about newly listed homes for several days after they are listed.

In any kind of market, and particularly in a buyers' market (where there are many more buyers than sellers) particularly at certain prices (e.g., below $500,000), a prospective homebuyer would have a great advantage if he or she were able to see a home before other homebuyers. In fact, in many cases, the time-advantage is such that the first person who is able to put in an offer will be the one to whom the sale is made.

### SUMMARY OF THE INVENTION

A listing and notification server receives real estate listing information from a mobile device of a real estate agent situated at a location where a listing agreement has moments before been entered into. The mobile device is preferably a smartphone that allows the agent to take various photos and video of the property, which can be uploaded together with a description of the property. The server pushes notifications of the new listing to a plurality of subscriber computing devices. The subscribers may include persons who indicated interest in buying real estate. The system can be configured such that notifications are sent to subscribers based on predetermined criteria, e.g., a specified price range. The listing information is added to a real estate listing database, which is a closed database searchable only by the subscribers. After a few days, the listing is removed from the real estate listing database to ensure freshness.

In an embodiment, the client-side mobile device is equipped with software capable of presenting the listing agreement to the home seller, and when the home seller agrees to the listing agreement by digitally signing the agreement, the real estate listing information is sent to the server, and the listing and notification steps are then performed.

### BRIEF DESCRIPTION OF THE DRAWINGS

FIG. 1 illustrates a rapid real estate listing and notification system, according to an embodiment.

FIG. 2 illustrates an example application interface useable to enter new listing information, useable in conjunction with the real estate listing and notification system, according to an embodiment.

FIG. 3 illustrates an example application interface useable to enter new listing information, useable in conjunction with the real estate listing and notification system, according to another embodiment.

FIG. 4 illustrates an example application interface useable by a subscriber in conjunction with the rapid real estate listing and notification system, according to an embodiment.

FIG. 5 illustrates the architecture of an example mobile device useable in conjunction with the rapid real estate listing and notification system, according to an embodiment.

FIG. 6 illustrates a server-side method for operation of the rapid real estate listing and notification system, according to an embodiment.

### DETAILED DESCRIPTION OF THE INVENTION

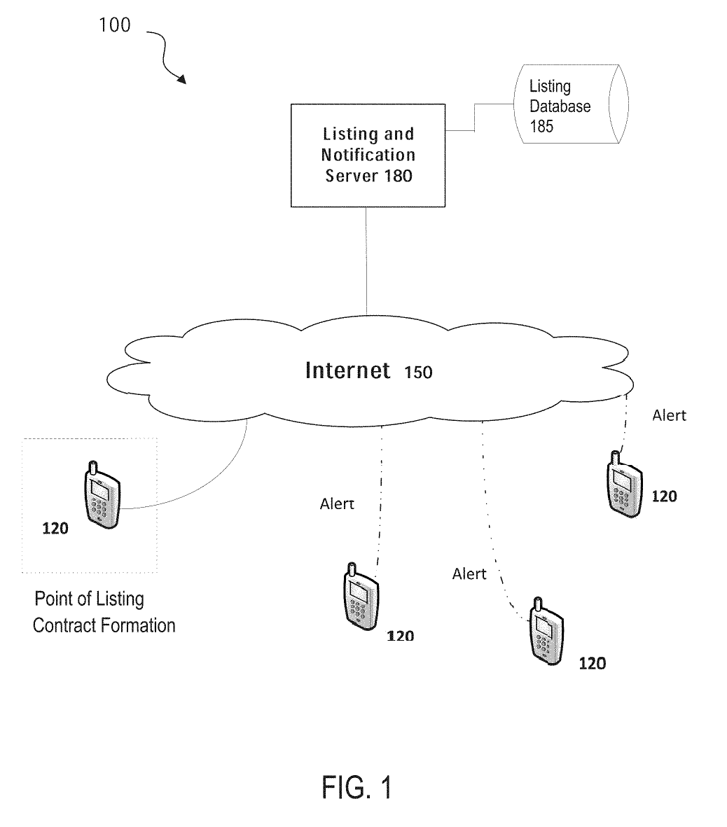

Referring to FIG. 1, a rapid real estate listing and notification system 100, according to an embodiment, is illustrated. As shown, the rapid real estate listing and notification system 100 includes a plurality of computing devices 120 that are communicatively connected via the Internet 150 to a listing and notification server 180. The listing and notification server 180 manages a listing database 185, which stores real estate listings. The computing devices 120 are preferably mobile computing devices, such as smartphones and tablet computers, but can include desktop and laptop computers, etc. As shown, there are four such computing devices 120. However, it is to be understood that the rapid real estate listing and notification system 100 is capable of accommodating many more such computing devices 120.

As will be described in greater detail, instead of waiting several days for a real estate listing to be made available, the present system allows a real estate agent situated at a location where a listing agreement has been entered into to send listing information for the property to a server for immediate listing. In particular, the agent is provided with a software application (“app”) installed on his or her computing device 120 to enter pertinent information regarding the property. Advantageously, the agent may use the same such device to take photos of the property, record video and/or audio regarding the listing, and upload this to the server as well. Once the listing information is sent to the listing and information server 180, the listing and notification server 180 substantially immediately sends notifications (alerts) of the new listing to a plurality of subscriber computing devices 120 regarding the new real estate listing. The listing information is added to the listing database 185, which is searchable by subscribers. Finally, after a predetermined length of time (e.g., about 48-72 hours), the listing will be deleted from the listing database 185, and no longer will be available to subscribers.

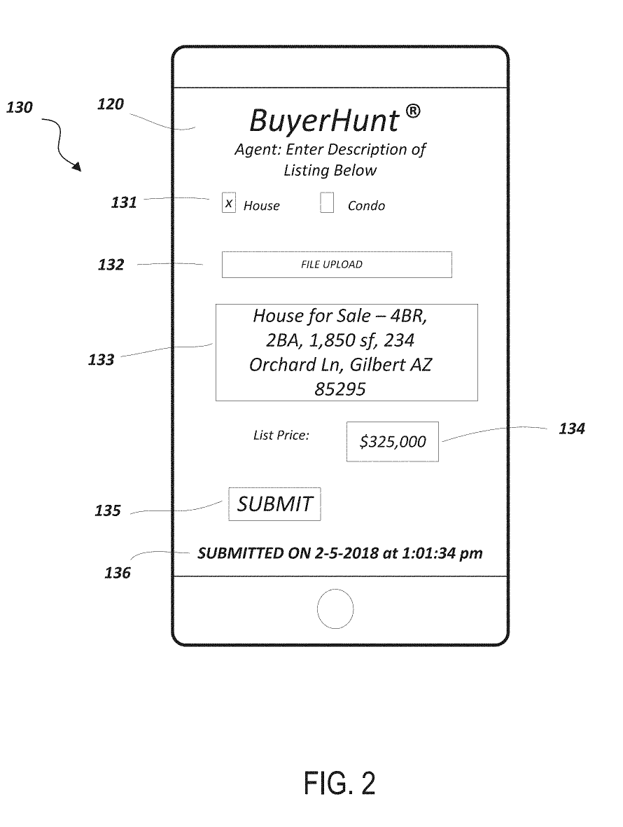

Referring to FIG. 2, an example application interface 130 useable to enter new listing information, useable in conjunction with the real estate listing and notification system 100, according to an embodiment, is illustrated. The example application interface 130 includes an example screen allowing real estate listing information to be entered. As shown, a real estate checkbox 131 is used to indicate the type of property. In this case, the agent has indicated that the property is a house. Although the choices of a “house” and “condo” (condominium) are illustrated, it is to be appreciated that many other categories of property could be included. File upload 131 is provided to upload digital media such as photos and videos of the property. Advantageously, the digital media may be created using the agent's computing device 120. Furthermore, in some cases more than one file upload 131 could be present on the screen to accommodate multiple files. In other cases, multiple files could be uploaded sequentially. Property description box 133 allows a description and address of the property to be entered. Although the property description box 133 shows freeform text, it is to be understood that preferably this same information would be entered using structured text entry boxes, pull-down menus, etc. In general, the manner in which the information on the application interface 130 is actually implemented will be a design choice. Property price box 134 shows the asking price for the property. It is to be understood that information entered would preferably be validated. Submit button 135 is provided so that the user can click or touch this area of the screen in order to submit the data, which can be an HTML form or the like, to the listing and notification server 180. In various implementations, the submit function can be provided differently, such as simply by allowing the user to make a certain finger gesture, a screen swipe, or the like. After the listing and notification server 180 has received the listing information from the agent's device 120, the listing information and notification server 180 will send back an acknowledgement. Preferably, the acknowledgement will include a timestamp. When the acknowledgement is received by the agent's computing device 120, an acknowledgement message, such as message 136, can be displayed on the agent's computing device 120, as shown.

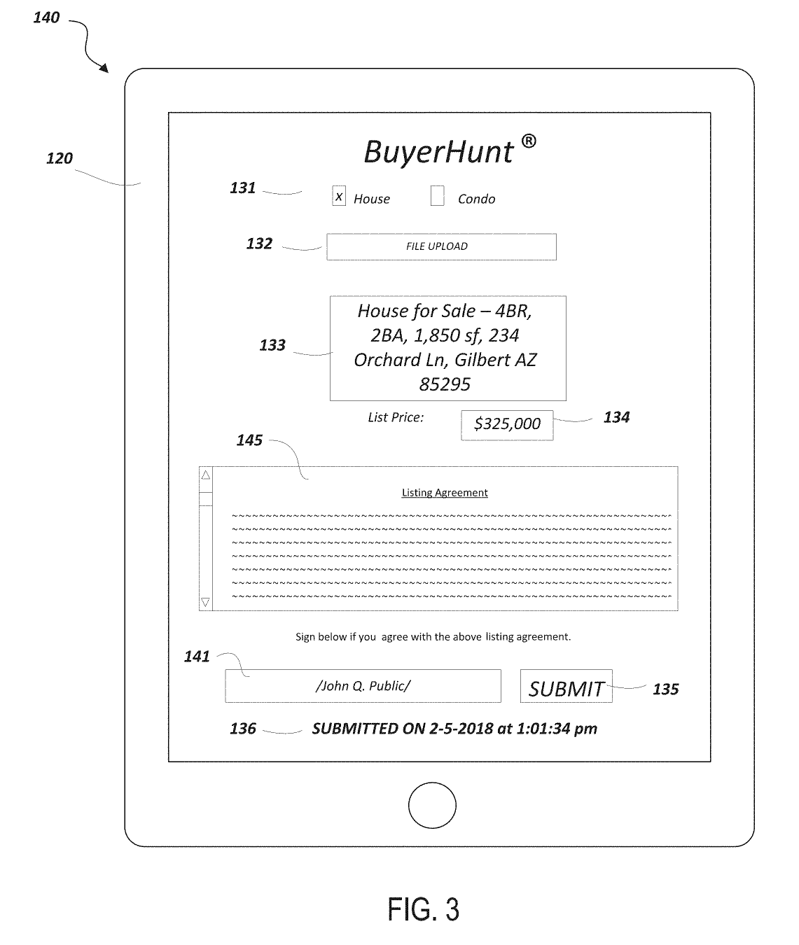

Referring to FIG. 3, an example application interface 140 useable to enter new listing information, useable in conjunction with the real estate listing and notification system 100, according to another embodiment, is illustrated. The example application interface 140 is substantially the same as the example application interface 130, except that a listing agreement is provided to the user, and the user can digitally sign the listing agreement, such that the listing information is submitted at the exact point at which the home seller enters into the agreement to list the property. It is to be understood that there are many suitable ways to present the listing agreement to the home seller, and the example provided herein is shown for illustrative purposes. As shown, the listing agreement is provided in a scrollable box 145, and the home seller would read the text of the listing agreement on the screen of the device until the end of the scrollable box 145 is reached. A signature box 141 is provided for the agreement to be digitally signed in a manner provided by law. Preferably, the computing device 120 will be a tablet computer. In various other embodiments, however, the computing device 120 can be a computer owned by the seller, and the entire information shown in the application interface 140 can be provided to the user as a webpage or the like. In this case, the agent would not even have to be physically present with the seller.

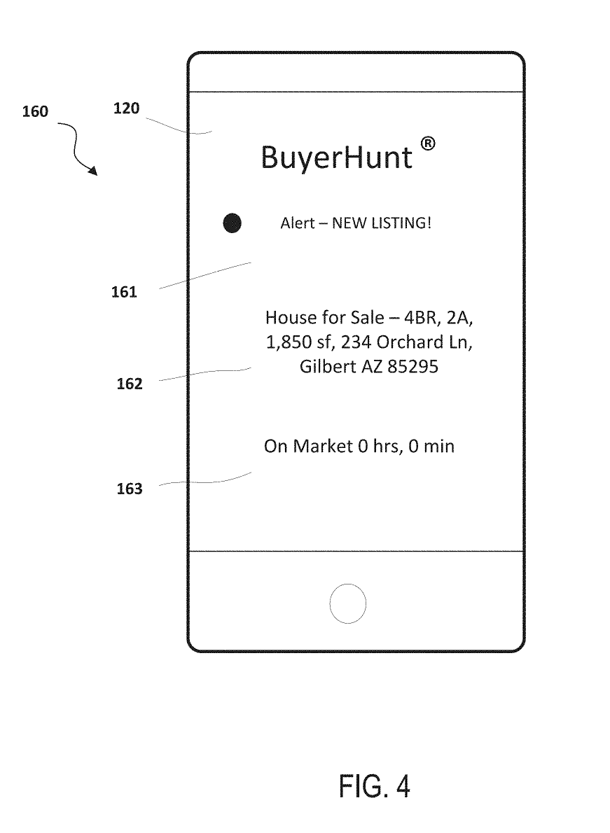

Referring to FIG. 4, an example application interface 160 useable by a subscriber in conjunction with the rapid real estate listing and notification system 100, according to an embodiment, is illustrated. The example application interface 160 includes an example screen showing a new listing alert. Preferably, the alert is pushed to the computing devices 120 of the subscribers, such as by a server push. However, alternatively, the alert may be obtained from the server using “polling” techniques, most preferably, by long polling. As shown, the new listing alert includes an alert message 161, which may include alert indicia (e.g., a blinking dot). In message 162, a description of the property may be shown. Finally, the length of time that the property has been on the market may be shown in time-on-market message 163. In this case, the newly listed property has just been listed, so the time-on-market message 163 shows that no time has elapsed since listing. As time goes by, the time-on-market can be incremented to show the amount of time the listing has been available. Uniquely, time on market is displayed in hours and minutes instead of days as used by MLS systems and other home search websites. As mentioned, the subscribers can view listed properties that match their home search criteria in the listing database 185, which is a closed database searchable by the subscribers.

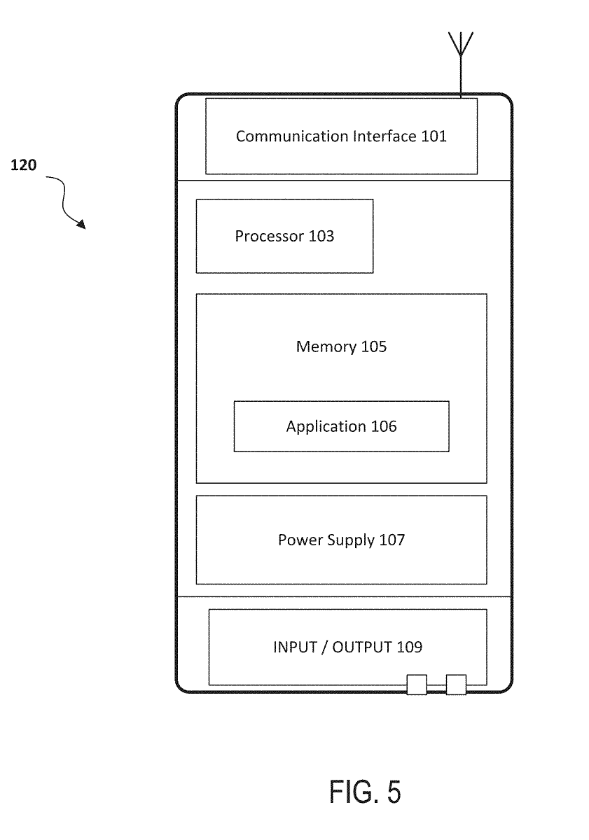

FIG. 5 shows a block diagram of a typical computing device 120 useable in conjunction with the listing and notification system 100, according to an embodiment. As depicted, the computing device 120 is a smartphone. It is to be understood that other such computing devices can be used, such as a tablet computer, a laptop computer, a desktop computer, etc. These devices will of course not include the cellular communication interface described below. As shown, the computing device 120 includes a communication interface 101, a processor 103, memory 105, a power supply 107, and input/output 109. In an embodiment, the communication interface 101 includes a cellular transmitter and receiver. The processor 103 includes a central processing unit (CPU). The memory can include ROM/RAM, flash memory and the like. The power supply 109 can include a re-chargeable battery and power charger. Application 106 is stored in the memory 105, and includes program code non-transitorily embedded thereon. This program code includes various programs executable by the processor 103 to interface with the listing and notification server 180, such as to enter new listing information (on the agent side) and to receive alerts (on the subscriber side). In general, the application 106 will include the software of the invention to effect the “client-side” methods described herein. In some cases, the software will include software that comes with the computing device 120 or was installed previously.

The rapid real estate listing system 100 includes a distributed application which is partitioned between a service provider (listing and notification server 180) and a plurality of service requesters (computing devices 120). Under this arrangement, a request-response protocol, such as hypertext protocol (HTTP), can be employed such that a client (computing device 120) can initiate requests for services from the server 180, and the server 180 can respond to each respective request by, for example, executing an application, and (where appropriate) sending results to the client (computing devices 120). The server 180 can also include the database 185 and a logic engine operatively linked to the server 180, allowing the application to query and store data therein. It is to be understood that in some embodiments, however, substantial portions of the application logic may be performed on the client using, for example, the AJAX (Asynchronous JavaScript and XML) paradigm to create an asynchronous web application. Furthermore, it is to be understood that in some embodiments the application can be distributed among a plurality of different servers (not shown).

In the present description of the present invention, exemplary methods for performing various aspects of the present invention are disclosed. It is to be understood that the steps illustrated herein can be performed by executing computer program code written in a variety of suitable programming languages, such as C, C++, C#, Visual Basic, and Java. It is also to be understood that the software of the invention will preferably further include various Web-based applications that can be written in HTML, PHP, Javascript, jQuery, etc., accessible by the clients using a suitable browser 145 (e.g., Internet Explorer, Microsoft Edge, Mozilla Firefox, Google Chrome, Safari, Opera) or as an application running on a suitable mobile device (e.g., an iOS or Android “app”).

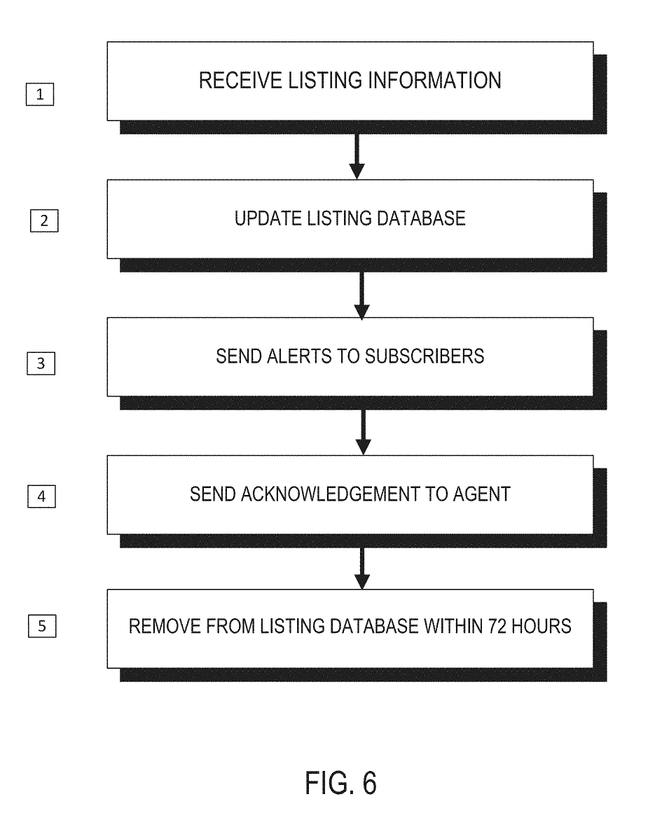

FIG. 6 illustrates a server-side method for operation of the rapid real estate listing and notification system 100, according to an embodiment. Although the illustrated method shows an ordering of steps, it is to be understood that steps 2-4 can be done in any order or concurrently. In step 1 (“Receive Listing Information”), the listing and notification server 180 receives from a computing device 120 of an agent new property listing information. The seller will have entered into a listing agreement shortly before this, and information regarding the property will be have been submitted at the property location by the agent. Next, in step 2 (“Update Listing Database”), the listing and notification server 180 will update the listing database 185 with the new property listing information provided in step 1. The listing database 185 can be a multimedia database capable of storing text as well as image files/video files/audio files. In step 3 (“Send Alerts to Subscribers”), the listing and notification server 180 pushes alerts to subscribers. To accomplish this, the listing and notification server 180 consults a list of subscribers and determines which subscribers have indicated that they would like to see such a listing. This is done by determining whether predetermined criteria for the subscriber matches characteristics of the new property listing. Such predetermined criteria can include a maximum property value, a minimum property value, a geographic location, number of bedrooms, number of baths, type of property, square footage, etc. For example, a subscriber may have indicated that he or she only wants to receive alerts for homes in “Chandler, Ariz.” that are priced less than “$400,000”. If such criteria are met, then the subscriber is provided the alert. Next, in step 4 (“Send Acknowledgment to Agent”), the listing and notification server 180 sends an acknowledgment to the computing device 120 of the agent noting that the new listing was processed. The acknowledgment preferably includes a time stamp for when the property was listed. Finally, as noted above, the listing and notification server 180 will eventually remove stale listings. In an embodiment, the listing and notification server 180 removes listings within a few days, most preferably within about 72 hours, to maintain a fresh set of listings.

While this invention has been described in conjunction with the various example embodiments outlined above, it is evident that many alternatives, modifications and variations will be apparent to those skilled in the art. Accordingly, the example embodiments of the invention, as set forth above, are intended to be illustrative, not limiting. Various changes may be made without departing from the spirit and scope of the invention.

What is claimed is:

1. A method for rapid notification of a real estate listing, comprising:
receiving from a mobile computing device situated at a location where a listing agreement has been formed a transmission containing real estate listing information regarding real estate listed according to the listing agreement; and
sending notifications to a plurality of computing devices via a network regarding the received real estate listing information.

2. The method of claim 1, wherein the notifications are push notifications sent to computing devices of subscribers.

3. The method of claim 1, wherein the subscribers include persons who indicated interest in buying real estate.

4. The method of claim 1, wherein the notifications are sent to selected subscribers according subscriber-based criteria.

5. The method of claim 4, wherein the subscriber-based criteria include one or more of a maximum property value, a minimum property value, a geographic location, number of bedrooms, number of baths, type of property, and square footage.

6. The method of claim 1, wherein the step of sending the notification is performed substantially immediately.

7. The method of claim 1, wherein the sent notification includes property identifying information.

8. The method of claim 1, wherein a description of the real estate is listed in a real estate listing database that is searchable by the subscribers only.

9. The method of claim 8, wherein the real estate listing is deleted from the real estate listing database within a predetermined length of time.

10. The method of claim 8, wherein the predetermined length of time is about 72 hours.

11. The method of claim 8, wherein the listing includes one or more of text descriptions, images of the property, video of the property, and audio.

12. The method of claim 1, further comprising receiving from the mobile computing device a second transmission of information regarding the real estate listing.

13. The method of claim 12, wherein the second transmission of information includes photos of the real estate being listed.

14. The method of claim 12, wherein the second transmission information is added to the real estate listing database for the real estate listing.

15. The method of claim 12, wherein second transmission is received within about an hour from the original transmission.

16. A system for rapid notification of a real estate listing, comprising:
a server configured to
receive, via a network, from a mobile computing device situated at a location where a listing agreement has been formed a transmission containing real estate listing information regarding real estate to be listed according to the listing agreement,
send push notifications to a plurality of computing devices via a network regarding the received real estate listing information;
update a real estate listing database with a listing with the real estate listing information; and
delete the real estate listing from the real estate listing database within a predetermined length of time.

17. The system of claim 16, where the predetermined length of time is about 72 hours.
